(19) United States
(12) Patent Application Publication
(10) Pub. No.: US 2010/0001533 A1
(43) Pub. Date: Jan. 7, 2010

(54) ALTERNATOR

(76) Inventor: John Leslie Jefferson, Athenry (IE)

Correspondence Address: BIRCH STEWART KOLASCH & BIRCH, PO BOX 747, FALLS CHURCH, VA, 22040-0747, US

(21) Appl. No.: 12/440,905

(22) PCT Filed: Aug. 30, 2007
(86) PCT No.: PCT/IE07/00079

§ 371 Date: Jul. 14, 2009

(30) Foreign Application Priority Data
Sep. 11, 2006 (IE) 2006/0667

(51) Int. Cl. F03D 9/00; H02K 21/24; H02K 11/04; H02P 9/48

(52) U.S. Cl. 290/55; 310/156.36; 310/68 D; 322/31

(57) ABSTRACT

An alternator (10) has a housing (11), a pair of opposed magnet end plates (12, 13) mounted within the housing (11) a coil plate (14) mounted in and held in position within the housing (11), between the pair of magnet end plates (12, 13). A drive shaft (15) is located within housing (11) and is coupled to the pair of magnet end plates (12, 13). Each magnet end plate (12, 13) has a plurality of permanent magnets (17) disposed thereon. The coil plate (14) has a plurality of magnet wire coils (not shown) embedded therewithin such that they can be seen from both sides of the coil plate (14). In use, turning of the drive shaft (15) causes the magnet end plates (12, 13) to move relative to the coil plate (14) thus exciting each magnet wire coil (not shown) on each side resulting in the generation of an alternating current therein.

### TECHNICAL FIELD

This invention relates to an alternator and, in particular, to a permanent magnet alternator for converting mechanical energy to alternating current electrical energy.

### BACKGROUND ART

Current permanent magnet alternators typically comprise a rotor or drive shaft, a magnet rotor assembly mounted for rotation on the rotor or drive shaft and a stationary stator with magnet wire coils disposed in the stationary stator. When a magnetic field flux is moved relative to a stationary electrical conductor such as copper wire, or vice versa, the magnetic field flux will induce an electromotive force (EMF) or voltage in the electrical conductor. If the conductor is connected to an electrical load, then current will flow. The magnet rotor assembly of current permanent magnet alternators rotates relative to the stationary stator and alternating current is generated in the magnet wire coils of the stationary stator. The magnet wire coils of the stationary stator are connected to a rectifier which converts the alternating current to direct current.

The primary advantage of such permanent magnet alternators over standard metal core alternators is that the loss of power output due to cogging and eddy currents is reduced to ˜3-4%. Permanent magnet alternators of the type described above have been designed and supplied by Scoraig Wind Electric of Dundonnell, Ross shire, IV23 2RE, U.K. for use in wind turbines.

However, a problem with the permanent magnet alternators described above is they have a relatively poor efficiency, that is, the electrical energy output is low in comparison to the mechanical energy input. The efficiency n of an alternator-rectifier system is determined from the formula:

n=P/P_{mech}×100%

where P is the true DC power output of the alternator-rectifier system and P_{mech} is the input mechanical power to the alternator. Measuring the power output from an alternator-rectifier system is straightforward—the voltage output can be measured using a voltmeter. The most direct way to measure the mechanical power in alternators is to measure the torque transmitted by the rotating shaft. This requires a special sensor and a system for transmitting data from this sensor. Permanent magnet alternators of the type described above have an efficiency of ˜40-60% based on the above formula.

Due to the fixed strength of the magnetic field generated by the permanent magnets, and the fixed number of windings in its coils, the voltage output (electrical energy output) of the permanent magnet alternator of the type described above will vary with the rate of change of the magnetic flux. The rate of change of the flux is directly proportional to the rotational speed of the permanent magnets. Therefore, controlling the speed of rotation or the employment of some type of external electrical control is necessary to maintain the output voltage at a regulated level. The efficiency of the permanent magnet alternator is thus adversely affected.

The permanent magnet alternators described above are also limited when the speed of the drive shaft is constant, in that only one pre-determined voltage output can be produced.

Thus, there is a need for an alternator with improved efficiency, that is, an alternator with a high electrical energy output from the mechanical energy input.

### DISCLOSURE OF INVENTION

Accordingly, the invention provides an alternator comprising a housing, a pair of opposed magnet end plates mounted within the housing, each magnet end plate having a plurality of permanent magnets disposed annularly and in alternating polarity on an inwardly facing planar surface thereof, each magnet on one opposed magnet end plate being aligned with a magnet of opposite polarity on the other magnet end plate, a coil plate mounted between the pair of magnet end plates, the coil plate having a plurality of magnet wire coils fixedly disposed therein, and a drive shaft coupled to either the pair of magnet end plates or the coil plate such that relative rotation therebetween excites each magnet wire coil on each side thereby generating alternating current.

Exciting the magnet wire coils of the coil plate on each side increases the voltage induced in the magnet wire coils of the coil plate. The overall voltage output induced when the magnet wire coils are excited on each side is consistently greater than the overall voltage output induced when the magnet wire coils of the coil plate are excited on one side only, the speed of the drive shaft being identical in each case. The number of amps of alternating current flowing in the alternator according to the invention is consequently greater than the number of amps of alternating current flowing in a standard permanent magnet alternator of similar size.

Therefore, the corresponding efficiency of the alternator according to the invention is consistently greater than the efficiency of a standard permanent magnet alternator of similar size.

In one embodiment of the alternator according to the invention, a plurality of inner magnet plates is mounted within the housing between the pair of opposed magnet end plates, each inner magnet plate having a plurality of permanent magnets disposed annularly and in alternating polarity on each planar surface thereof, the magnets on the opposed planar surfaces of the inner magnet plates being aligned with the magnets on the magnet end plates, with the aligned magnets on adjacent magnet plates having opposite polarities, and wherein a coil plate is mounted between adjacent magnet plates.

Each coil plate is excited on each side bay adjacent magnet plates and thus also exhibits the characteristic of increased voltage output. The arrangement of the magnet plates and corresponding coil plates as described above allows for the generation of one constant voltage output when the speed of the drive shaft is variable and the generation of multiple constant voltage outputs when the speed of the drive shaft is constant, as will be described below in greater detail.

In addition, the positioning of the permanent magnets on the magnet end plates and inner magnet plates as described above means that, in operation, the torque load on the magnet plates is reduced to the load, i.e., the required voltage output, taken out of the alternator. It is only the magnet end plates that experience an inner torque load. The magnet plates can be of lighter construction than known alternators of similar output.

The design of the above alternator—having few moving parts, no parts which rub or wear against each other, magnet wire coils having no core as opposed to wire coils wound around iron cores, and reduced torque load on the magnet plates—reduces the loss of power output due to cogging and eddy currents to almost 0%.

Preferably, the or each coil plate is connectable to a rectifier for converting the alternating current to direct current.

Almost all appliances in the modern world operate using direct current as opposed to alternating current. Thus, the alternating current output of the alternator according to the invention must be converted to direct current.

In a further embodiment of the alternator according to the invention, the magnet plates are mounted for rotation on the drive shaft and the or each coil plate is held in position by the housing.

Rotation of the magnet plates relative to the or each coil plate is most effective for the inducing voltage in the magnet wire coils; the voltage induced when the magnet wire coils are excited on each side is consistently greater than the voltage induced when the magnet wire coils of the coil plate are excited on one side only.

In a further embodiment of the alternator according to the invention, the or each coil plate is mounted for rotation on the drive shaft and the magnet plates are held in position by the housing.

Rotation of the or each coil plate relative to the magnet plates is also effective for inducing voltage in the magnet wire coils; the voltage induced when the magnet wire coils are excited on each side is consistently greater than the voltage induced when the magnet wire coils of the coil plate are excited on one side only.

Preferably, the magnet wire coils are connectable to the or each rectifier by a slip ring mounted on the drive shaft.

The alternating current generated in the or each rotating coil plate is transferred to the or each rectifier by a slip ring. in a further embodiment of the alternator according to the invention, each coil plate generates a pre-determined voltage output per r.p.m. of the drive shaft.

Preferably, the number of windings of the magnet wire coils of each coil plate determines the voltage output per r.p.m. of the drive shaft for that coil plate.

The magnet wire coils of each individual coil plate can be wound so that each coil plate produces a different voltage output per r.p.m. of the drive shaft. This allows for the production of one constant voltage output when the speed of the drive shaft is variable and the production of multiple constant voltage outputs when the speed of the drive shaft is constant.

In a further embodiment of the alternator according to the invention, the drive shaft is operable at varying speeds.

Preferably, the alternator further comprises means for measuring the r.p.m. of the drive shaft.

Further preferably, the means for measuring the r.p.m. of the drive shaft is a sensor.

Still further preferably, a control unit monitors the voltage output from the coil plates and provides a constant voltage output from the alternator.

Most preferably, the control unit is a programmable logic controller (PLC), which switches individual coil plates into or out of circuit according to the RPM of the drive shaft.

The magnet wire coils of each individual coil plate are wound so that each coil plate produces a different voltage output per r.p.m. of the drive shaft. The PLC monitors the r.p.m. of the drive shaft and, therefore, the voltage output of the alternator—the r.p.m. of the drive shaft and the voltage output of the alternator being directly related to one another. The PLC identifies a first coil plate with a relevant voltage output per r.p.m. of the drive shaft and switches this first coil plate into circuit. As the r.p.m. of the drive shaft varies, the PLC switches the first coil plate out of circuit, identifies a second coil plate with a relevant voltage output per r.p.m. of the drive shaft and switches this second coil plate into circuit. The process of switching individual coil plates into and out of circuit according to the speed of the drive shaft allows for the generation of one constant voltage output when the speed of the drive shaft is variable.

In one embodiment, the PLC switches individual coil plates out of circuit when the r.p.m. of the drive shaft results in generation of an excess of the voltage output required.

The PLC monitors the r.p.m. of the drive shaft and, therefore, the voltage output of the alternator. If the voltage output of the alternator is in excess of the voltage output required, the PLC switches individual coil plates out of circuit in order to prevent a voltage spike in any appliance drawing current from the alternator.

In a further embodiment of the alternator according to the invention, the drive shaft is connectable to a wind turbine.

In a still further embodiment of the alternator according to the invention, the drive shaft is operable at a constant speed.

Preferably, multiple pre-determined voltage outputs can be generated and a PLC can switch individual coil plates into or out of circuit according to the particular voltage outputs required.

The r.p.m. of the drive shaft is constant and the magnet wire coils of each individual coil plate are wound so that each coil plate produces a different voltage output per r.p.m. of the drive shaft. The PLC identifies the coil plates with the voltage output per r.p.m. of the drive shaft relevant to the particular voltage outputs required and switches these coil plates into circuit. This allows for the generation of multiple constant voltage outputs when the speed of the drive shaft is constant.

In a further embodiment, the drive shaft is connectable to a combustion engine.

In a still further embodiment of the alternator according to the invention, high impedance bleeding resistors prevent voltage spikes in any unused or out of circuit coil plates.

Preferably, the magnet plates are constructed from of any one of the following materials stainless steel, stainless steel alloys, aluminium, and aluminium alloys.

Preferably, the coil plates are constructed from a non-conducting material, such as fibre glass.

### BRIEF DESCRIPTION OF THE DRAWINGS

FIG. 1 is a side elevation in cross-section of a first embodiment of the alternator according to the invention;

FIG. 2 is an end elevation of a magnet end plate of the alternator of FIG. 1;

FIG. 3 is an end elevation of the coil plate of the alternator of FIG. 1;

FIG. 4 is an end elevation of a spacer of the alternator of FIG. 1;

FIG. 5 is an end elevation of the coil plate, the magnet end plate and the spacer in situ of the alternator of FIG. 1;

FIG. 6 is a side elevation in cross-section of a second embodiment of an alternator according to the invention;

FIG. 7 is a schematic representation of the embodiment of FIG. 6 illustrating the forces on the magnet plates in use; and

FIG. 8 is a schematic representation of the electrical circuit of the alternator of FIG. 6.

### MODES FOR CARRYING OUT THE INVENTION

The invention will be further illustrated by the following description of embodiments thereof, given by way of example only with reference to the accompanying drawings.

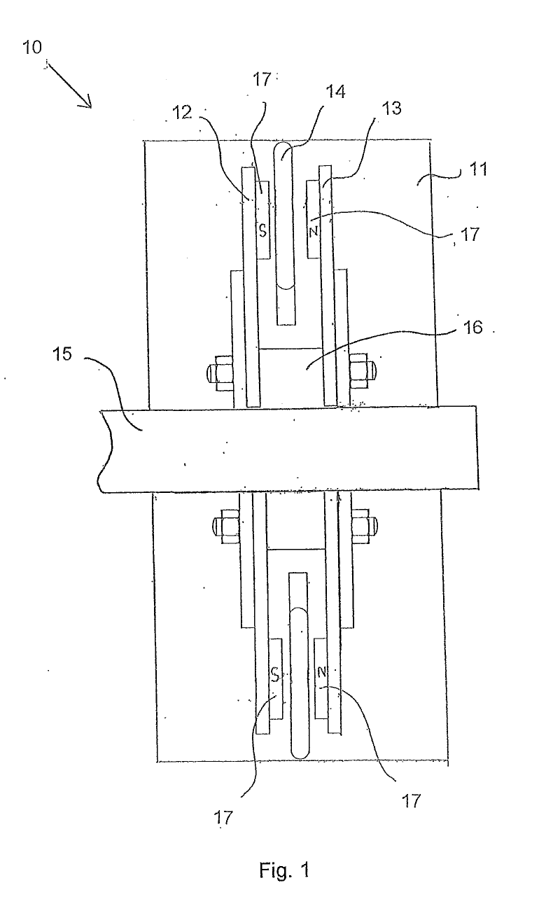

Referring to FIG. 1, there is indicated, generally at 10, an alternator, in accordance with the invention, the alternator 10 comprising a housing 11, a pair of opposed magnet end plates 12, 13 mounted within housing 11, a coil plate 14 mounted in and held in position within the housing 11, between the pair of magnet end plates 12, 13. A drive shaft 15 is located within the housing 11 and is coupled to the pair of magnet end plates 12, 13. A spacer 16, on the drive shaft 15, maintains a set distance between the pair of magnet end plates 12, 13.

Each magnet end plate 12, 13 has a plurality of permanent magnets 17 disposed thereon. Each magnet 17 on the opposed magnet end plate 12 is aligned with a magnet 17 of opposite polarity on the other magnet end plate 13.

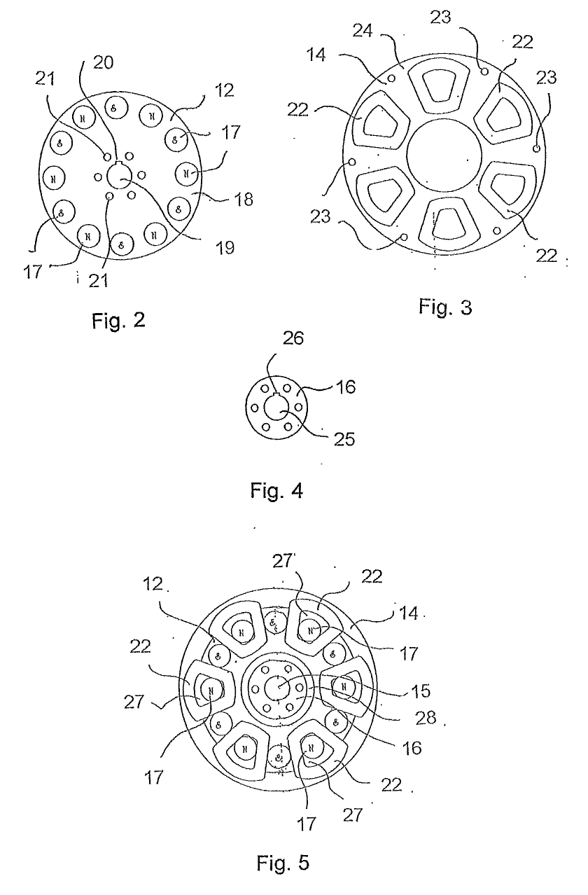

Referring to FIG. 2, the magnet end plate 12 is shown in more detail. The plurality of permanent magnets 17 is disposed annularly and in alternating polarity on an inwardly facing planar surface 18 thereof. A central hole 19 has a locating slot 20 arranged therein, which slot 20 cooperates with a complementary ridge (not shown) mounted axially along the shaft 15 for aligning the two magnet plates one to the other. A set of bolt holes 21, in the surface 18, facilitates the bolting of the magnet end plates 12, 13 together.

The magnet end plate 13 has identical features to the magnet end plate 12, except that the polarity of the magnets is reversed.

Referring to FIG. 3, the coil plate 14 is shown in more detail. The coil plate 14 has a plurality of magnet wire coils 22 equally spaced apart and embedded therewithin, such that each magnetic wire coil 22 can be seen from both sides. The magnet wire coils 22 are connected to a rectifier (not shown) for converting alternating current to direct current in use. A set of retaining holes 23 located around outer edge 24 of the coil plate 14 are adapted for receipt of retaining bolts (not shown) for holding the coil plate 14 in position within the housing 11 (FIG. 1).

Referring to FIG. 4, the spacer 16 is shown in more detail. A centrally located hole 25 is suitable for accommodating the shaft 15 and includes a locating slot 26 similar to the slot 20 in the magnet end plate 12.

In use, rotation of the magnet end plates 12, 13 relative to the coil plate 14 excites each magnet wire coil 22 on each side thereby generating alternating current therein. It will be apparent that the overall voltage output generated when the magnet wire coils 19 are excited on each side is greater than the overall voltage output that would be generated if the magnet wire coils 19 of the coil plate 14 were excited on one side only, the speed of the drive shaft 15 being identical in each case.

Therefore, the efficiency of the alternator 10 is consistently greater than the efficiency of standard permanent magnet alternators of similar size.

Referring to FIG. 5, the arrangement of the magnet end plate 12, the coil plate 14 and the spacer 16 can be seen in more detail. Each magnet wire coil 22 is wound in a generally trapezoidal shape around an open core 27 through which a magnet 17 on the magnet end plate 12 can be seen. The coil plate encircles the drive shaft 15 and the spacer 16, which are free to spin within a central opening 28 of the coil plate 14.

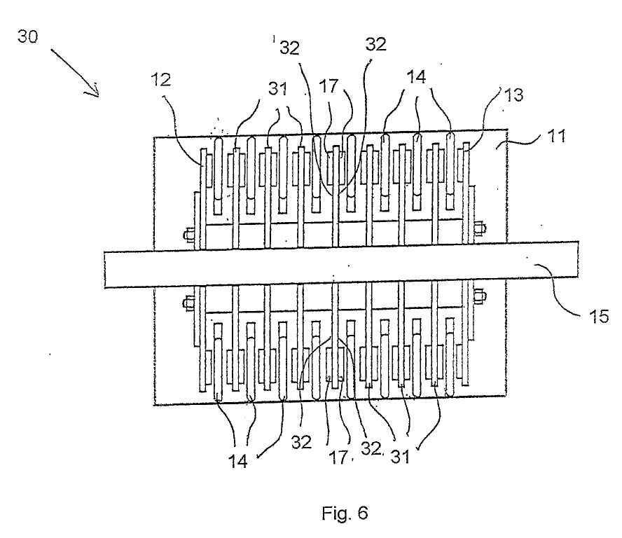

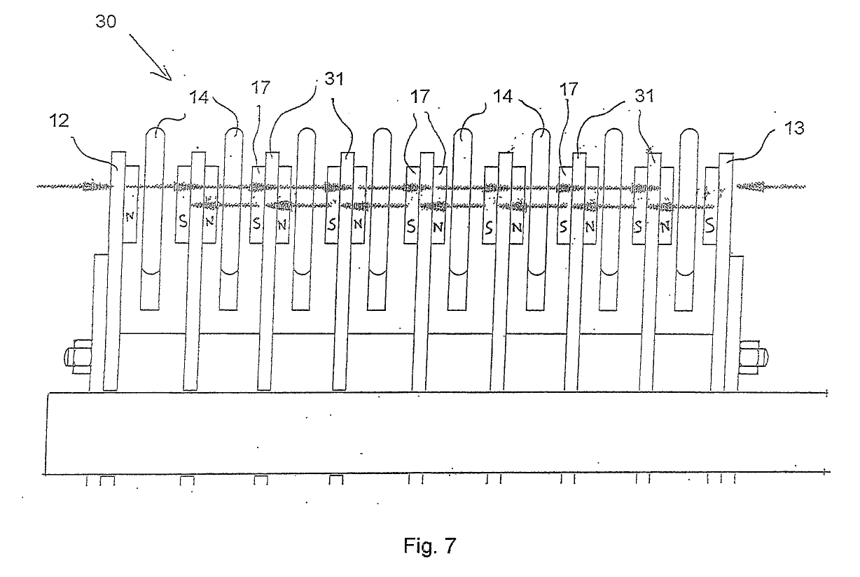

Referring to FIG. 6 there is indicated, generally at 30, a second embodiment of the alternator according to the invention, wherein like parts to those of the first embodiment are denoted by the same reference numerals. A plurality of inner magnet plates 31 is mounted on the drive shaft 15 within the housing 11 between the pair of opposed magnet end plates 12, 13. A coil plate 14 is mounted between adjacent magnet plates 12, 13, and 31.

Each inner magnet plate 31 has a plurality of permanent magnets 17 disposed annularly and in alternating polarity on each planar surface 32 thereof. The magnets 17 on the opposed planar surfaces 32 of the inner magnet plates 31 are aligned with the magnets 17 on the magnet end plates 12, 13 and the aligned magnets 17 on the adjacent magnet plates 12, 13, and 31 have opposite polarities.

The magnet wire coils (not shown) of each individual coil plate 14 of the alternator 30 are wound so that each coil plate 14 produces a different voltage output per r.p.m. of the drive shaft 15.

Referring to FIG. 7, the positioning of the permanent magnets 17 on the magnet end plates 12, 13 and the inner magnet plates 31 means that, in operation, the torque load oil the inner magnet plates 31 is reduced to a load being drawn from the alternator 30. It is only the magnet end plates 12, 13 that experience an inner torque load.

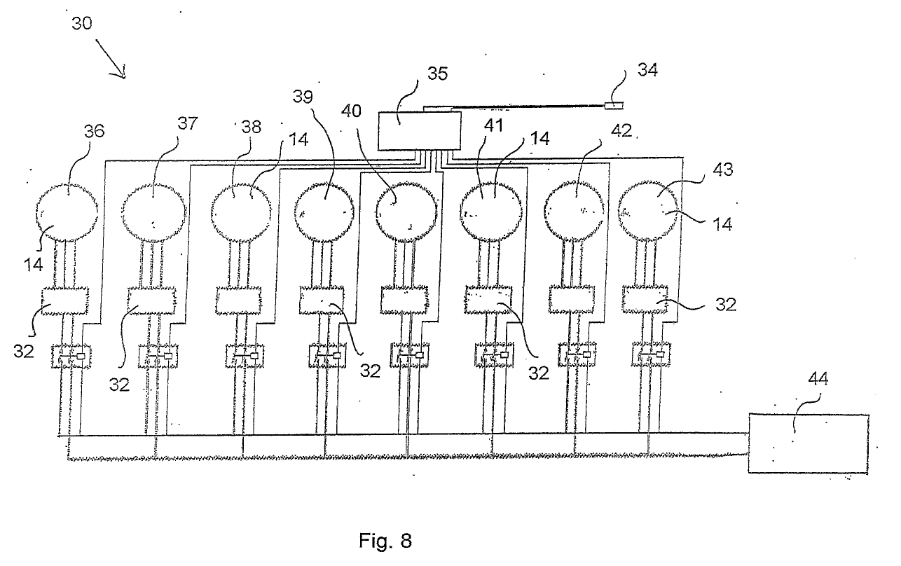

Referring to FIG. 8, each coil plate 14 of the alternator 30 is connected to a rectifier 32 for converting alternating current to direct current. The alternator 30 further comprises a sensor 34 and a PLC 35. The sensor 34 measures the r.p.m. of the drive shaft (not shown) and also measures the torque transmitted by the rotating drive shaft (not shown). At least one of the coil plates 14 is connected to the PLC 35 by all analog input (lot shown) and the PLC 35 thereby monitors the voltage output from the coil plates 14. The data collected by the sensor 34 is transmitted to the PLC 35. The PLC 35 switches individual coil plates 14 into or out of circuit according to the r.p.m. of the drive shaft 15.

In use when the drive shaft (not shown) is operable at varying speeds, the PLC 35 monitors the r.p.m. of the drive shaft 15 and, therefore, the voltage output of the alternator 30—the r.p.m. of the drive shaft and the voltage output of the alternator 30 being directly related to one another. The PLC 35 identifies a first coil plate 36 of the plurality of coil plates 14 with a relevant voltage output per r.p.m. of the drive shaft and switches this first coil plate 36 into circuit. As the r.p.m. of the drive shaft varies, the PLC 35 switches the first coil plate 36 out of circuit, identifies a second coil plate 37 with a now relevant voltage output per r.p.m. of the drive shaft and switches this second coil plate 37 into circuit. Individual coil plates 14 are continuously switched into and out of circuit in response to variations in the r.p.m. of the drive shaft and corresponding variations in the overall voltage output from the alternator 30. One constant voltage output is generated.

The PLC 35 switches individual coil plates 14 out of circuit when the r.p.m. of the drive shaft results in generation of an excess of the voltage output required thereby preventing a voltage spike in a load 44 drawing current from the alternator 30.

Referring generally to FIGS. 6 to 8, the alternator 30 is set up to deliver 12 volts over a drive shaft 15 speed varying between 60-240 r.p.m. The alternator 30 has seven inner magnet plates 31 mounted within the housing 11 between the pair of opposed magnet end plates 12, 13. Eight coil plates 36 to 43 are mounted between the adjacent magnet plates 12, 13, and 31.

In use coil plates 36 to 39 are switched into and out of circuit individually by the PLC 35. The coil plates 40 and 41 and the coil plates 42 and 43 are switched into and out of circuit in pairs.

Therefore, six different coil plates/combination of coil plates 14 can be engaged over the speed difference of 240 r.p.m.. Each coil plate/coil plate combination 14 operates in a range of 40 r.p.m. (240/6−40 r.p.m.).

The load 44 drawing current from the alternator 30 is a 12 volt battery. Therefore, the voltage output required from the alternator 30 system is 12 volts.

The coil plate 36 operates in the 60-100 r.p.m. range. In order to produce 12 volts, the magnet wire coils of the coil plate 36 are wound so as to produce 0.2 volts per r.p.m. of the drive shaft 15.

At 60 r.p.m.×0.2 volts=12 volts

At 100 r.p.m.×0.2 volts=20 volts

Voltage Difference=8 volts

The coil plate 37 operates in the 100-140 r.p.m. range. In order to produce 12 volts, the magnet wire coils of the coil plate 37 are wound so as to produce 0.12 volts per r.p.m. of the drive shaft 15.

At 100 r.p.m.×0.12 volts=12 volts

At 140 r.p.m.×0.2 volts=16.8 volts

Voltage Difference=4.8 volts

The coil plate 38 operates in the 140-180 r.p.m. range. In order to produce 12 volts, the magnet wire coils of the coil plate 38 are wound so as to produce 0.086 volts per r.p.m. of the drive shaft 15.

At 140 r.p.m.×0.086 volts=12 volts

At 180 r.p.m.×0.086 volts=15.48 volts

Voltage Difference=3.48 volts

The coil plate 39 operates in the 180-220 r.p.m. range. In order to produce 12 volts, the magnet wire coils of the coil plate 39 are wound so as to produce 0.067 volts per r.p.m. of the drive shaft 15.

At 180 r.p.m.×0.067 volts=12 volts

At 220 r.p.m.×0.067 volts=14.74 volts

Voltage Difference=2.74 volts

The coil plates 40 and 41 operate in the 220-260 r.p.m. range. In order to produce 12 volts, the magnet wire coils of the coil plates 40 and 41 are wound so as to collectively produce 0.055 volts per r.p.m. of the drive shaft 15.

At 220 r.p.m.×0.055 volts=12.1 volts

At 260 r.p.m.×0.055 volts=14.3 volts

Voltage Difference=2.2 volts

The coil plates 42 and 43 operate in the 260-300 r.p.m. range. In order to produce 12 volts, the magnet wire coils of the coil plates 42 and 43 are wound so as to collectively produce 0.046 volts per r.p.m. of the drive shaft 15.

At 220 r.p.m.×0.046 volts 12 volts

At 260 r.p.m.×0.046 volts=13.8 volts

Voltage Difference=1.8 volts

The PLC 35 switches the coil plate 36 into circuit as soon as the speed of the drive shaft 15 reaches 60 r.p.m.. The coil plate 36 will continue to operate in the range of 60-100 r.p.m.. The maximum voltage difference that can be obtained is 8 volts. The excess voltage output is regulated down to 12 volts by a voltage regulator (not shown).

As soon as the speed of the drive shaft reaches 100 r.p.mn., the PLC 35 switches the coil plate 36 out of circuit and switches the coil plate 37 into circuit. The coil plate 37 operates in the range of 100-140 r.p.m.. The maximum voltage difference that can be obtained is 4.8 volts. Again, the excess voltage output is regulated down to 12 volts by the voltage regulator.

The process of switching coil plates 14 into and out of circuit continues as the speed of the drive shaft approaches 300 r.p.m..

A prior art permanent magnet alternator can also be designed to generate 12 volts when the speed of the drive shaft is 60 r.p.m.. However, the same permanent magnet alternator would generate 60 volts when the speed of the drive shaft is 300 r.p.m.. It is difficult to regulate 60 volts down to the required 12 volts. In contrast, the excess voltage output generated in the alternator 30 becomes less and less as the speed of the drive shaft 15 increases, therefore, allowing the excess voltage output to be regulated down to the required voltage output much more easily.

The PLC 35 switches individual coil plates 14 out of circuit when the r.p.m. of the drive shaft 15 results in generation of an excess of the minimum voltage output allowable when each individual coil plate 14 is in circuit, in this case, 12 volts. This prevents a voltage spike in any appliance drawing current from the alternator.

1-22. (canceled)

23. An alternator comprising a housing, a pair of opposed magnet end plates mounted within the housing, each magnet end plate having a plurality of permanent magnets disposed annularly and in alternating polarity on an inwardly facing planar surface thereof, each magnet on one opposed magnet end plate being aligned with a magnet of opposite polarity on the other magnet end plate, a plurality of inner magnet plates being mounted within the housing between the pair of opposed magnet end plates, each inner magnet plate having a plurality of permanent magnets disposed annularly and in alternating polarity on each planar surface thereof, the magnets on the opposed planar surfaces of the inner magnet plates being aligned with the magnets on the magnet end plates, with the aligned magnets on adjacent magnet plates having opposite polarities, a coil plate mounted between each magnet end plates and the inner magnet plate next thereto, a further coil plate mounted between adjacent magnet plates, each coil plate having a plurality of magnet wire coils fixedly disposed therein, and a drive shaft coupled to either the pair of magnet end plates and to the inner magnet plates or the coil plates such that relative rotation therebetween excites each magnet wire coil on each side thereby generating alternating current and such that each coil plate generates a pre-determined voltage output per r.p.m. of the drive shaft.

24. An alternator according to claim 23, wherein the number of windings of the magnet wire coils of each coil plate determines the voltage output per r.p.m. of the drive shaft for that coil plate.

25. An alternator according to claim 23, wherein each coil plate is connectable to a rectifier for converting the alternating current to direct current.

26. An alternator according to claim 25, wherein the magnet plates are mounted for rotation on the drive shaft and the coil plates are held in position by the housing.

27. An alternator according to claim 25, wherein each coil plate is mounted for rotation on the drive shaft and the magnet plates are held in position by the housing.

28. An alternator according to claim 27, wherein the magnet wire coils are connectable to each rectifier by a slip ring mounted on the drive shaft.

29. An alternator according to claim 23, wherein the drive shaft is operable at varying speeds.

30. An alternator according to claim 29, which further comprises means for measuring the r.p.m. of the drive shaft.

31. An alternator according to claim 30, wherein the means for measuring the r.p.m. of the drive shaft is a sensor.

32. An alternator according to claim 29, wherein a control unit monitors the voltage output from the coil plates and provides a constant voltage output from the alternator.

33. An alternator according to claim 32, wherein the control unit is a programmable logic controller (PLC), which switches individual coil plates into or out of circuit according to the r.p.m. of the drive shaft.

34. An alternator according to claim 33, wherein the PLC switches individual coil plates out of circuit when the r.p.m. of the drive shaft results in generation of an excess of the voltage output required.

35. An alternator according to claim 29, wherein the drive shaft is connectable to a wind turbine.

36. An alternator according to claim 23, wherein the drive shaft is operable at a constant speed.

37. An alternator according to claim 36, wherein multiple pre-determined voltage outputs can be generated and a programmable logic controller (PLC) can switch individual coil plates into or out of circuit according to the particular voltage outputs required.

38. An alternator according to claim 37, wherein the drive shaft is connectable to a combustion engine.

39. An alternator according to claim 33, wherein high impedance bleeding resistors prevent voltage spikes in any unused or out of circuit coil plates.

40. An alternator according to claim 23, wherein the magnet plates are constructed from of any one of the following materials stainless steel, stainless steel alloys, aluminium, and aluminium alloys.

41. An alternator according to claim 23, wherein the coil plates are constructed from a non-conducting material.
